(19) United States
(12) Patent Application Publication
(10) Pub. No.: US 2014/0228723 A1
(43) Pub. Date: Aug. 14, 2014

(54) ROLLER BALL MASSAGE INSTRUMENT

(71) Applicants: Matthew Cockerill, London (GB); Laurence Willmott, London (GB)

(72) Inventors: Matthew Cockerill, London (GB); Laurence Willmott, London (GB)

(73) Assignee: HANDSOME LIMITED, Radcliffe (GB)

(21) Appl. No.: 14/354,676

(22) PCT Filed: Oct. 29, 2012
(86) PCT No.: PCT/GB2012/052691

§ 371 Date: Apr. 28, 2014

(30) Foreign Application Priority Data
Oct. 27, 2011 (GB) 1118606.1

(51) Int. Cl. A61H 15/02

(52) U.S. Cl. CPC A61H 15/02
USPC 601/128

(57) ABSTRACT

A roller-ball massage instrument (10) comprises a ball support (14) arranged to support a ball (12) protruding from and rotatable with respect to the ball support (14), a retainer (16) cooperable with the ball support (14), and a holder (18) positionable between the ball support (14) and the retainer (16) to hold the ball support (18).

The present invention relates to massage instruments, and in particular to massage instruments for dispensing massage liquids, such as oils or creams, during use of the instrument.

Massage instruments allow users to impart massaging forces that cannot be applied by the hands alone. They also aid users by reducing the stress experienced by the hands, wrists and arms when massaging, and can be used to facilitate self massage, enabling the user to reach awkward areas such as the shoulders and back. The simplest massage instruments are formed from an elongate piece of material such as wood, metal or plastic, and are shaped to allow the user to grip a handle part of the instrument whilst using a head part of the instrument to perform the massage.

Massage liquids are commonly used for therapeutic purposes, to enhance the pleasure of the massage, and to reduce friction between a massage instrument and the skin. When using a simple massage instrument, the massage liquid must be dispensed separately onto the area to be massaged, which involves an additional operation and can be cumbersome for the user. This is particularly problematic when self-massaging areas that are difficult to reach, such as the back or shoulders.

To overcome this problem, massage instruments that dispense massage liquids have been developed. For example, a ‘roller ball’ structure has been applied to massage instruments to dispense massage liquids during use of the instrument.

Also available are roller ball massage instruments in which the roller ball does not dispense liquid, but is instead used simply to reduce friction between the massage instrument and the skin by virtue of rolling contact. The massage liquid is applied to the massage area separately. In these instruments the ball may be removable from a socket of the instrument to allow the ball to be heated or cooled, or to allow balls of different materials or sizes to be used.

Thorough cleaning of roller ball massage instruments is essential because mixing of different massage liquids is undesirable, and because any massage liquid remaining in the instrument attracts dirt, which can harden in the instrument preventing the roller ball from rotating smoothly. A significant disadvantage of current roller ball massage instruments is that they are difficult to clean between uses. Even if the ball is removable, cleaning the socket is laborious and time-consuming because of the complicated mechanisms such as snap-rings, hinges and latches that are required to retain the ball in the socket whilst allowing it to be removed when required.

This problem is particularly apparent when the user wishes to use different massage liquids, or different massage balls at different stages of the massage, or on different massage subjects. The massage instrument must either be cleaned thoroughly when the massage liquid is changed, which is inconvenient and disruptive to the massage, or it must be exchanged for a different massage instrument that dispenses a different massage liquid, meaning that multiple instruments are required.

In summary, therefore, known massage instruments are inconvenient to use, particularly for massages involving more than one massage liquid, and when improperly cleaned are unhygienic and ineffective. Because of this they are often eschewed by potential users in favour of simpler instruments.

Accordingly, it would be desirable to provide a massage instrument that overcomes the problems outlined above.

The invention may be expressed as a roller-ball massage instrument comprising a ball support arranged to support a ball protruding from and rotatable with respect to the ball support, a retainer cooperable with the ball support, and a holder to hold the ball support.

Optionally, the holder may be positionable between the ball support and the retainer.

In one embodiment of the invention, the ball support comprises an opening for receiving a massage liquid. When in use for attaching the ball support to the holder, the retainer closes the opening, and the ball, the ball support and the retainer define a cavity in communication with an outer surface of the ball, the cavity being capable of holding a massage liquid. In this way the ball support and/or the retainer prevent massage liquid in the cavity contacting the holder.

The ball support may be removably attachable to the retainer. The ball support may be removably attachable to the holder. The holder may comprise a socket and at least one of the ball support and the retainer may extend at least partially through the socket to cooperate with each other, for example by means of complementary screw threads. A female-threaded part may lie between a male-threaded part and the holder.

The ball support and the holder may be cooperable by means of a push fitting, which may be a bayonet fitting.

The ball support, the holder and the retainer may be mutually cooperable.

The ball support may comprise a spigot and a collar, the spigot being narrower than the collar, and the collar may overlap the spigot to define a ball support shoulder that bears against the holder. The socket may be surrounded by a flange on an inner side of the handle so that the ball support shoulder bears against the flange.

The retainer may comprise a skirt and a disc, the skirt being narrower than the disc, and the disc may overlap the skirt to define a retainer shoulder. The socket may comprise a stepped inner profile that defines a seat surface against which the retainer shoulder bears in use.

In one embodiment, the ball is insertable into, and removable from, the ball support.

The holder may be clamped between the ball support and the retainer. In one embodiment, the holder is an elongate handle having a head portion toward one end for holding the ball support and a handgrip portion toward the other end.

The ball support may be formed as a single piece. Alternatively, the ball support may comprise an inner housing and an outer housing. The inner housing may comprise an opening for receiving the massage instrument. In use, the outer housing may close the opening.

The ball, the inner housing and the outer housing may define a cavity in communication with an outer surface of the ball, the cavity being capable of holding a massage liquid.

In embodiments where the ball support comprises an inner housing and an outer housing, the outer housing may be arranged to receive the inner housing.

The ball, the ball support and the retainer may constitute a cartridge removable from the holder, such that the holder may be re-used with a fresh cartridge. Alternatively, the ball and the ball support may constitute a cartridge removable from the holder, such that the holder and the retainer may be re-used with a fresh cartridge. In one embodiment, the retainer may be integrated with the holder.

The invention extends to a cartridge for use with the massage instrument, comprising a ball support arranged to support a ball protruding from and rotatable with respect to the ball support, and a retainer cooperable with the ball support. The cartridge may be pre-filled with a massage liquid in a cavity defined by the ball, the ball support and the retainer.

The invention also extends to a cartridge for use with the massaging instrument comprising a ball support arranged to support a ball protruding from and rotatable with respect to the ball support, the ball support having an attachment formation for attaching the cartridge to the retainer. The cartridge may be pre-filled with a massage liquid in a cavity defined by the ball and the ball support.

The invention may also be expressed as a roller-ball massage instrument comprising a handle and a cartridge containing massage liquid and having a ball protruding from and rotatable with respect to the remainder of the cartridge to apply the massage liquid to a subject in use, wherein the cartridge is removably attachable to the handle such that the handle can be reused with a fresh cartridge.

The invention further extends to a roller-ball massage instrument kit comprising a handle and a set of cartridges, each containing massage liquid and having a ball protruding from, and rotatable with respect to, the remainder of the cartridge to apply the massage liquid to a subject in use, wherein each cartridge of the set is removably attachable to the handle such that the handle can be reused with a fresh cartridge.

The invention also extends to a set comprising a plurality of cartridges. Optionally, different cartridges of the set contain different massage liquids or different cartridges of the set may have balls of different size, material, structure, content or composition.

Preferred and/or optional features of the various embodiments and aspects of the invention may be incorporated alone, or in appropriate combination, in any other aspects or embodiments of the invention.

In order that the invention may be more readily understood, reference will now be made, by way of example, to the accompanying drawings, in which:

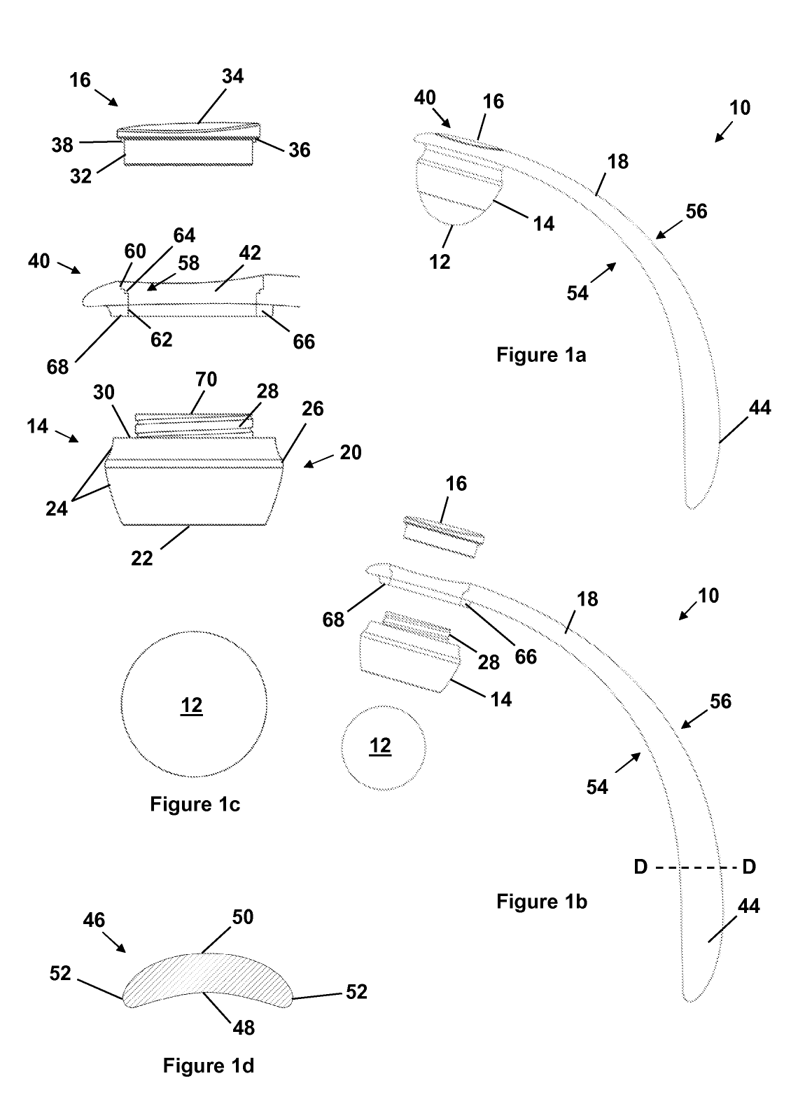

FIG. 1a is a side view that shows a massage instrument according to the present invention, in an assembled state;

FIG. 1b is an exploded side view of the instrument of FIG. 1a;

FIG. 1c is an enlarged detail exploded side view showing a ball, ball support and retainer of the instrument of FIG. 1a;

FIG. 1d is a cross-section on line D-D of FIG. 1b;

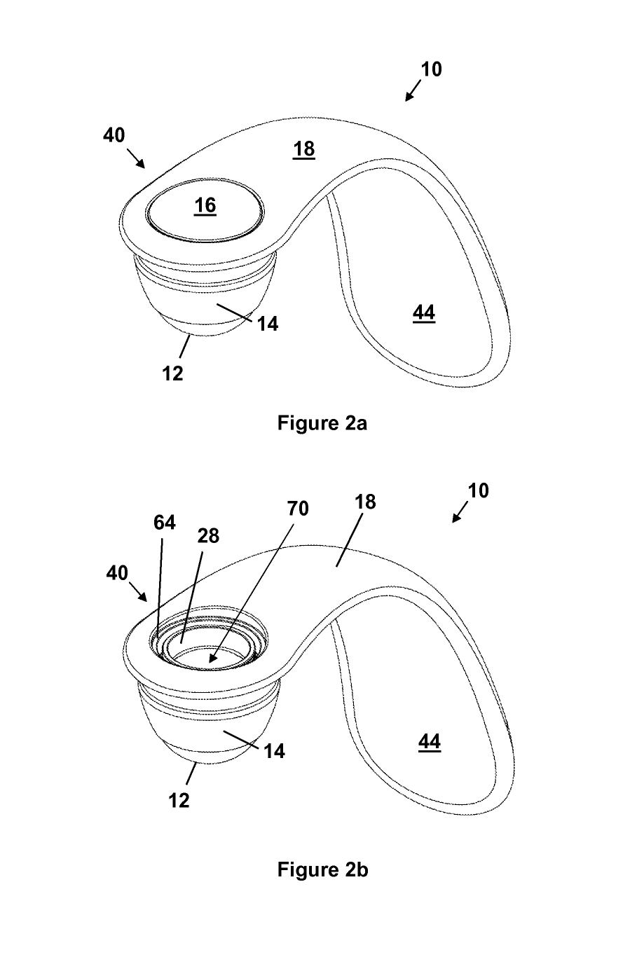

FIGS. 2a and 2b are perspective views of the instrument of FIG. 1a from the side, end and above, FIG. 2a showing the instrument with a retainer and FIG. 2b showing the instrument without the retainer;

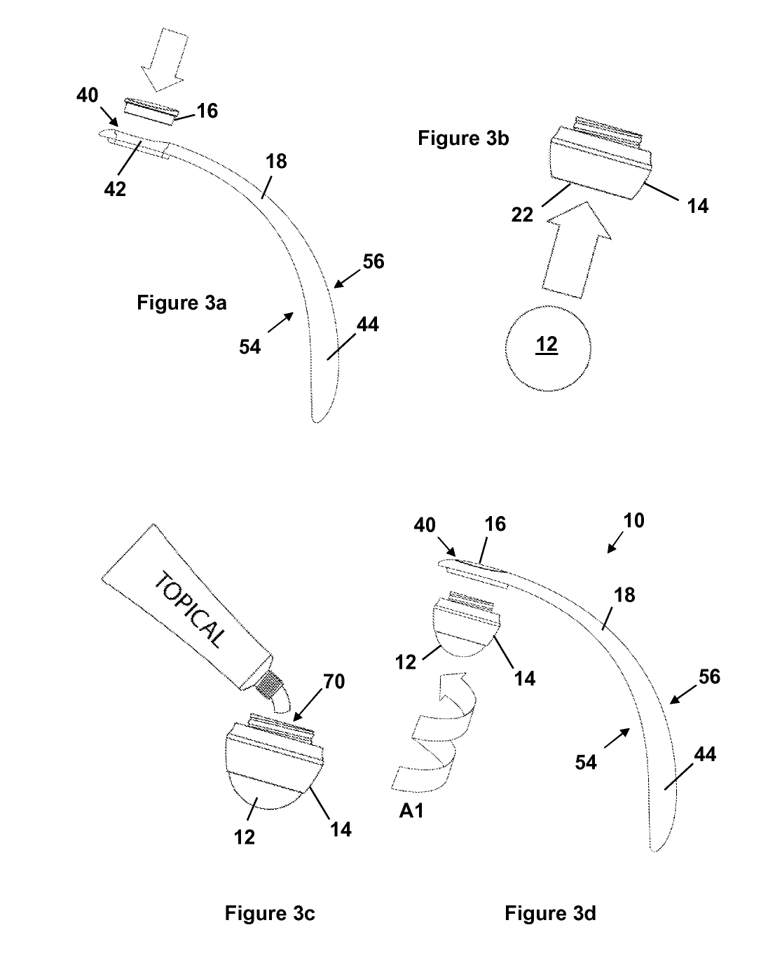

FIGS. 3a to 3d are a sequence of side views showing a method of assembly of the massage instrument of FIG. 1a;

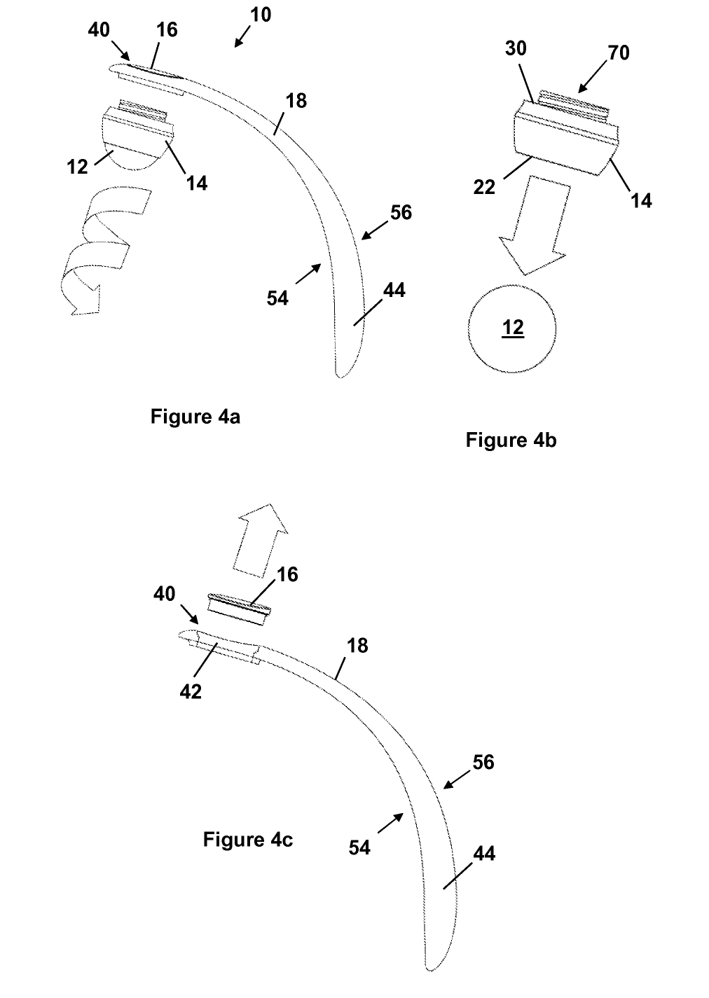

FIGS. 4a to 4c are a sequence of side views showing a method of disassembly of the massage instrument of FIG. 1a;

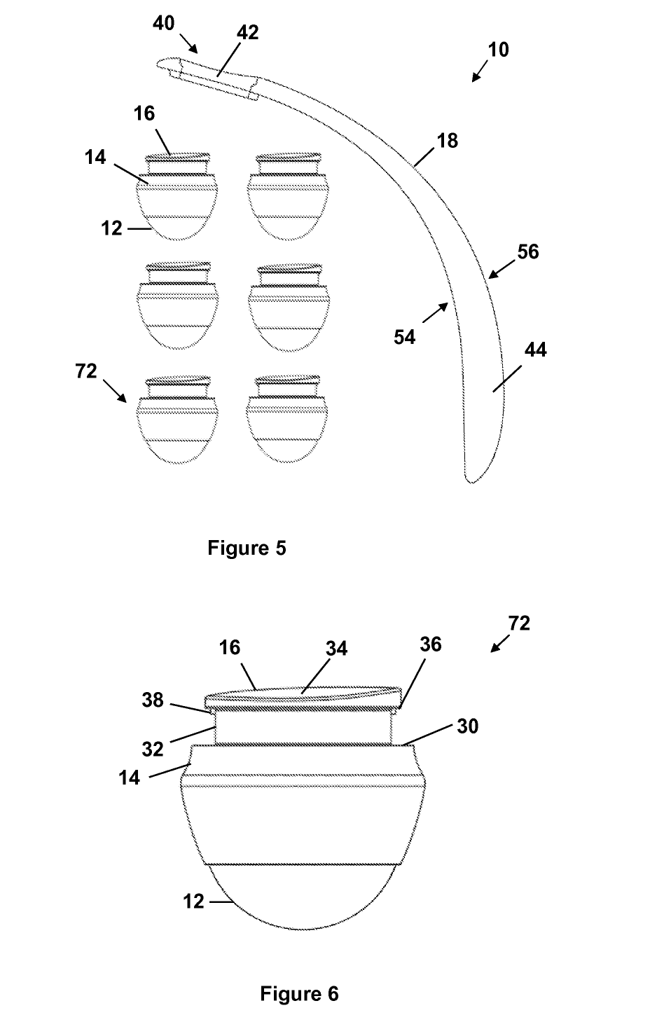

FIG. 5 is a side view of a massage instrument being a further embodiment of the invention, comprising a handle and a set of cartridges each comprising a ball, a ball support and a retainer;

FIG. 6 is an enlarged detail side view of a cartridge being one of the set shown in FIG. 5;

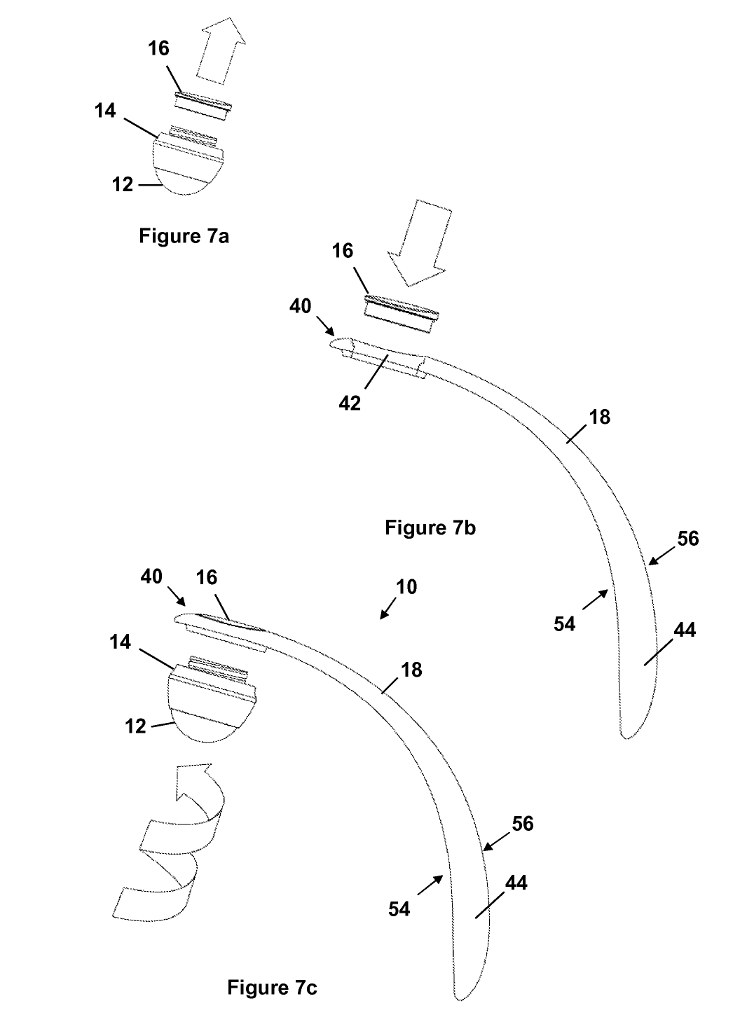

FIGS. 7a to 7c are a sequence of side views showing a method of assembly of the massage instrument of FIG. 5;

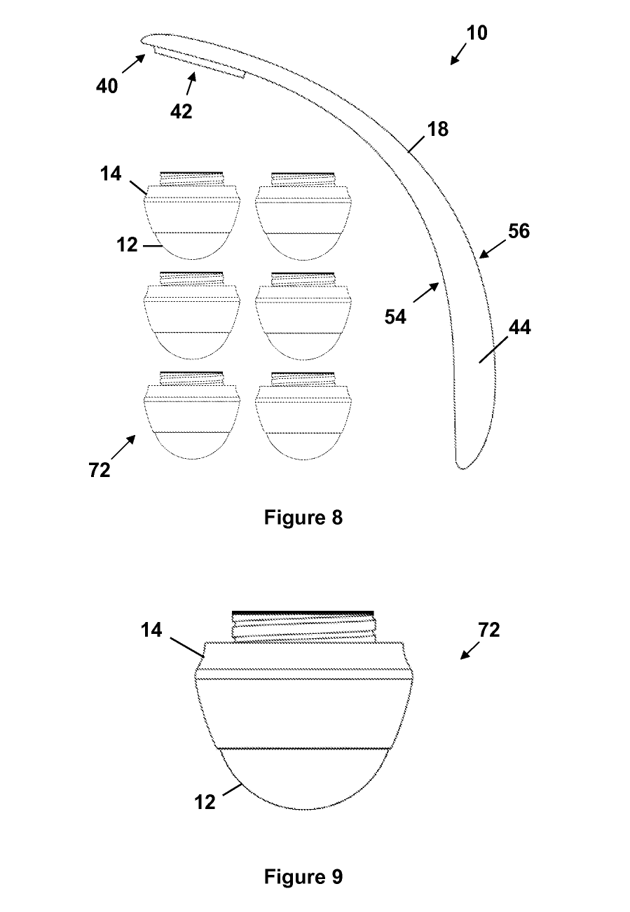

FIG. 8 is a side view a massage instrument being another embodiment of the invention comprising a handle and a set of cartridges each comprising a ball and a ball support but with no separate retainer;

FIG. 9 is an enlarged detail side view of a cartridge being one of the set shown in FIG. 8;

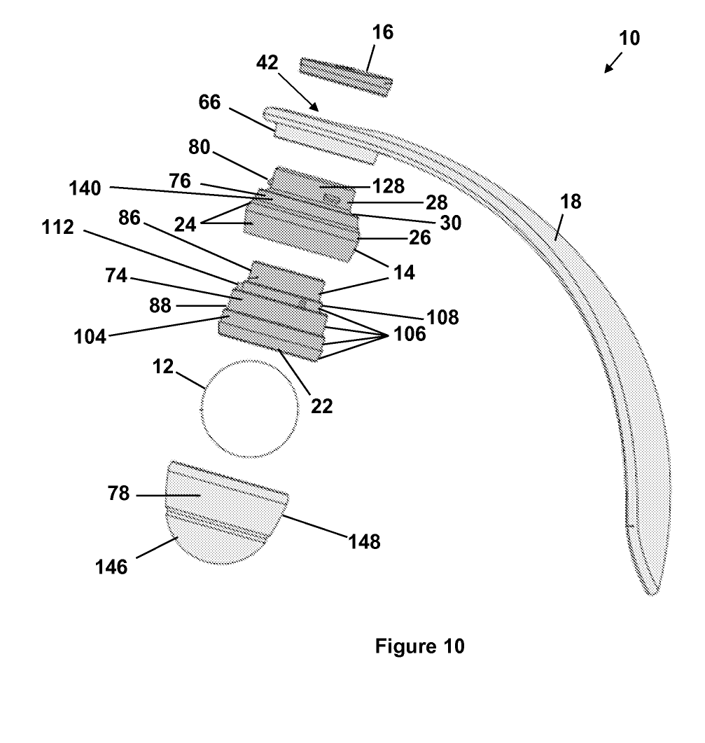

FIG. 10 is an exploded side view of massage instrument according to an another embodiment of the invention;

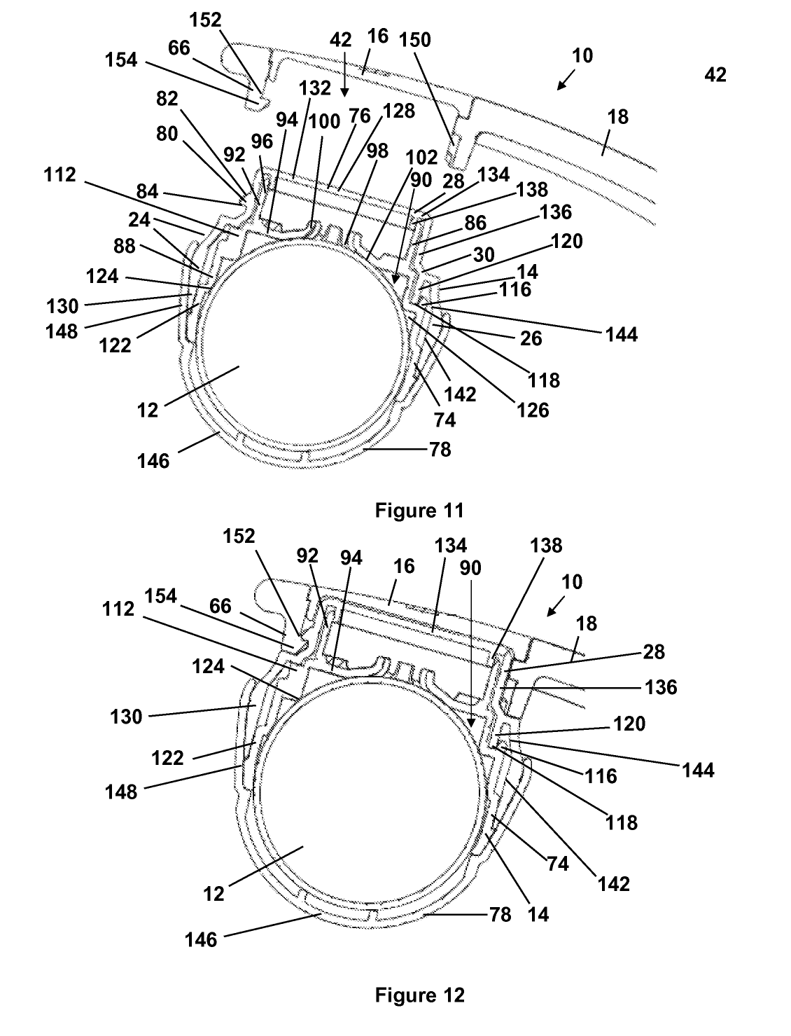

FIG. 11 is an enlarged detail cross-sectional view showing a cartridge for use with a holder and a retainer of the instrument of FIG. 10; and

FIG. 12 is an enlarged detail cross-sectional view showing the cartridge of FIG. 11 in use with the holder and the retainer.

Throughout this specification, terms such as ‘upper’ and ‘lower’ are used with reference to the orientation of the massage instrument as shown in the accompanying Figures. ‘Upper’ refers to a position generally towards the retainer, and ‘lower’ to a position generally towards the ball. Terms such as ‘downward’ and ‘upward’ refer to corresponding directions. It will be appreciated that when in use or in storage, the massage instrument may adopt any orientation.

Referring to FIGS. 1a to 1d of the drawings, a massage instrument 10 according to the present invention comprises a ball 12, a ball support 14, a retainer 16, and a handle 18 that serves as a holder for the ball support 14.

The ball 12 may be made from any suitable material such as wood, metal, plastics or stone and may be solid or hollow. As is known in the prior art, different ball materials and structures may be selected depending upon the purpose of the ball 12, for example to cool or heat the subject's skin. It is also known for a ball 12 to be hollow and filled with a massage liquid that oozes through a porous wall of the ball 12.

The ball support 14, best shown in FIG. 1c, comprises an annular collar 20 that defines a ball aperture 22. The external shape of the collar 20 comprises two opposed frustoconical sections 24 joined at their mutual base 26. Internally, as is well-known in the art of roller ball massage instruments, the collar 20 is shaped with bearing surfaces (not shown) to receive and retain the ball 12. The ball aperture 22 is narrower than the diameter of the ball 12, so that the ball 12 cannot drop through the ball aperture 22.

The ball support 14 further comprises a male attachment formation, here being integral with the collar 20 and in the form of a male-threaded spigot 28 centred upon an axis aligned with the central axis of the collar 20. The ball support 14 may be made from any suitable material such as plastics or metal, but injection-moulded plastics is preferred for lightness and low cost.

The spigot 28 of the male attachment formation is narrower than the adjoining part of the collar 20, such that an annular shoulder 30 is defined by the overlapping outer portion of the collar 20.

When the massage instrument 10 is assembled, as shown in FIG. 1a, the ball 12 is rotatably supported by the ball support 14 and protrudes through the ball aperture 22, so that the ball 12 can be rolled over the skin of a massage subject.

Optionally, as shown, the ball 12 is insertable into, and removable from, the ball support 14. This may be achieved by forming at least part of the ball support 14 from a flexible and resilient material so that the ball aperture 22 can be enlarged elastically to allow the ball 12 to be forced through the aperture 22.

The retainer 16, best shown in FIG. 1c, comprises a female attachment formation in the form of a skirt 32 having a female screw thread (not shown) complementary to the male screw thread of the spigot 28 of the ball support 14. The retainer 16 further comprises an enlarged disc 34 that preferably, as shown, is integral with the skirt 32 of the female attachment formation. In side view, the disc 34 being of greater diameter than the skirt 32 confers a ‘T’ shape on the retainer 16, with an annular shoulder 36 being defined by the overlapping outer portion of the disc 34. Integrally-moulded lugs 38 protrude from the shoulder 36 at the junction between the disc 34 and the skirt 32.

The retainer 16 may be made from any suitable material such as plastics or metal. Again, injection-moulded plastics is preferred for lightness and low cost.

As best shown in FIG. 1b, the elongate handle 18 has a head portion 40 (FIG. 1c) at one end having a socket 42 for holding the ball support 14 and a handgrip portion 44 at the other end to be held by a user. The handle 18 is ergonomically shaped, with a thickened handgrip portion 44 so that the instrument 10 can be comfortably held by the user.

The handle 18 is curved along its length such that the head portion 40 is at an obtuse angle to the handgrip portion 44. Where the user is also the subject, the curved shape of the handle 18 facilitates self-massage so that the user can easily reach areas such as the back and shoulders that would otherwise be difficult to massage.

The handle 18 is strong and durable, so as to allow the user to apply sufficient massaging force without damaging the handle 18. Preferably the handle 18 has a smooth gloss-like finish, so as to allow the handle 18 to be wiped clean easily.

As shown in the cross-section 46 of FIG. 1d, the handle 18 has a cross-section 46 whose width is substantially greater than its thickness. In the example shown, the cross-section 46 is banana-shaped, comprising a concave inner face 48 and a convex outer face 50 joined by radiused edges 52. In use of the instrument 10, the concave inner face 48 receives the user's fingers for secure grip and the convex outer face 50 is received by the palm of the user's hand for the user's comfort. The radius of the concave inner face 48 increases moving toward the head portion 40 of the handle 18, becoming substantially planar around the socket 42 where the ball support 14 meets the handle 18.

The socket 42 of the handle 18 comprises a circular hole extending through the cross-section of the handle 18 at its head portion 40. When the instrument 10 is assembled, the spigot 28 of the ball support 14 and the skirt 32 of the retainer 16 extend into or through the hole, with the ball support 14 being disposed on an inner side 54 of the handle 18 and the retainer 16 being disposed on an outer side 56 of the handle 18.

The handle 18 is held between the ball support 14 and the retainer 16, which are attached to one another by cooperation of their male and female threads. In the embodiment shown, this involves screwing the spigot 28 of the ball support 14 into the skirt 23 of the retainer 16. Conversely, the ball support 14 and the retainer 16 may be removed from the handle 18 by unscrewing the spigot 28 of the ball support 14 from the skirt 32 of the retainer 16.

The hole of the handle 18 has a stepped inner profile 58 (see FIG. 1c) shaped to accommodate the retainer 16, so that the retainer 16 lies substantially flush with the outer surface 56 of the handle 18 or protrudes only minimally from that outer surface 56. Specifically, the inner profile 58 of the hole is ‘T’ shaped, to accommodate the ‘T’ shape of the retainer 16. Thus, the inner profile 58 comprises a circular outer wall 60 whose diameter slightly exceeds the diameter of the disc 34 of the retainer 16. The profile 58 further comprises a circular inner wall 62 whose diameter slightly exceeds the outer diameter of the skirt 32 of the retainer 16, but is less than the diameter of the disc 34 of the retainer 16. A seat surface 64 defined between the inner 62 and outer 60 walls forms a seat for the opposed shoulder 36 of the retainer 16.

The seat surface 64 of the hole has slots (not shown) cooperable with the lugs 38 of the retainer 16 to lock the retainer 16 against rotation with respect to the handle 18 when the skirt 32 of the retainer 16 is inserted into the hole 42. Thus, the skirt 32 of the retainer 16 is inserted into the hole 42 with the lugs 38 aligned with the slots and then the spigot 28 of the ball support 14 is simply screwed into the skirt 32 of the retainer 16.

The disc 34 of the retainer 16 is not of uniform thickness but instead tapers toward the head end 40 of the handle 18. The outer wall 60 of the hole 42 is shaped to match this, being lower toward the head end 40 of the handle 18 and being higher on the opposite side. This asymmetry makes it advantageous for the lugs 38 of the retainer 16 and the slots of the hole to be positioned such as to allow the retainer 16 to sit in the hole in only one, correct orientation.

The inner side 54 of the handle 18 has a flange 66 surrounding the inner wall 62 of the hole. The flange 66 defines an annular seat surface 68 that lies in a plane orthogonal to the central longitudinal axis of the hole 42. The flange 66 locally thickens the handle 18 to strengthen the threaded engagement between the retainer 16 and the ball support 14 and to strengthen the connection between the retainer 16, the ball support 14 and the handle 18. The flange 66 does so without compromising the elegant slimness of the remainder of the handle 18.

Preferably, the ball support 14 and the retainer 16 exert a clamping force on the handle 18, so that the handle 18 is fixed with respect to the ball support 14 and the retainer 16. Opposed clamping forces are exerted via the shoulders 30, 36 of the ball support 14 and the retainer 16 bearing, respectively, against the seat surfaces 68, 64 of the flange 66 and of the hole 42.

In the embodiment shown (see e.g. FIGS. 2a and 2b), the ball support 14 has an opening 70 for the introduction of massage liquid, such as oils or creams, into a cavity (not shown) in communication with the outer surface of the ball 12. The cavity may be arranged to hold, for example, approximately 5 to 6 ml of massage liquid. Advantageously, the opening 70 is defined by the spigot 28 being hollow and open-ended so that when the instrument 10 is assembled, the opening 70 is closed by the retainer 16. Thus, the ball 12, the ball support 14 and the retainer 16 together define the cavity. When the instrument 10 is in use, the ball 12 turns and dispenses massage liquid from the cavity onto the skin of the massage subject.

A further advantage of closing the opening 70 of the ball support 14 with the retainer 16 is that the ball 12, the ball support 14 and the retainer 16 can together form a sealed cartridge unit 72 that can be supplied separately from the handle 18. On assembly with the handle 18, the retainer 16 can be removed temporarily from the ball support 14 and seated in the handle socket 42 before the ball support 14 is reattached to the retainer 16 to attach the ball support 14 and the ball 12 to the handle 18.

Optionally, the ball 12 may be protected by a removable or disposable cover that fits to the ball support 14, for example with a screw thread, by adhesive or with a push-fit.

Such a cartridge 72 is apt to be pre-filled with massage liquid. The cartridge 72 may be re-filled or, simply, discarded and replaced with a fresh cartridge 72 which may itself be pre-filled. Thus, there is no need for cleaning in the event that a ball 12 is to be replaced or a different massage liquid is to be used.

The massage instrument 10 may be provided in an assembled state, as shown in FIG. 1a, or in a disassembled state as shown in FIG. 1b. To assemble the instrument 10 from its disassembled state, the user inserts the retainer 16 into the socket 42 of the handle 18, as shown in FIG. 3a. If the ball 12 is provided separately from the ball support 14, the user inserts the ball 12 into the ball support 14 by pushing the ball 12 through the ball aperture 22, shown in FIG. 3b.

With the ball 12 supported by the ball support 14, massage liquid may be introduced into the cavity through the opening 70 in the spigot 28 of the ball support 14 as shown in FIG. 3c. The ball 12 fits into the ball aperture 22 tightly enough that the massage liquid does not leak from the ball aperture 22, but is loose enough that a small amount of massage liquid may be rolled out of the ball support 14 on the surface of the ball 12 as the ball 12 is rotated in the ball support 14. The ball support 14 is then attached to the retainer 16, as shown in FIG. 3d, by rotation indicated by arrow A1, to engage the screw threads. In this way the handle 18 is held between the ball support 14 and the retainer 16.

The user then performs a massage by rolling the ball 12 of the massage instrument 10 over a subject's skin. The rolling action of the ball 12 applies massage liquid in a well-known manner.

Specifically, friction between the subject's skin and the ball 12 causes the ball to rotate. The rotation causes massage liquid on an outer surface of the ball 12 to be carried from the cavity and through the ball aperture 22, to the subject's skin. Advantageously, when the skin is sufficiently lubricated by massage liquid, the friction between the subject's skin and the ball 12 is reduced, such that the ball 12 no longer rotates. In this way, massage liquid is only dispensed onto the subject's skin when the patient's skin is sufficiently dry (for example, the massage liquid has been massaged into the skin, or the instrument is moved to a new area), and over-application is avoided.

Advantageously, if further massage liquid is required during use of the instrument 10, the ball support 14 may be removed from the retainer 16 and additional massage liquid may then be poured into the cavity through the opening 70 in the spigot 28 of the ball support 14. The ball support 14 may then be reattached to the retainer 16 so that the massage can continue.

Advantageously, as shown, the instrument 10 may be disassembled after use. To disassemble the instrument 10, the ball support 14 is unscrewed from the retainer 16, as shown in FIG. 4a, and the retainer 16 is removed from the handle 18, as shown in FIG. 4c. The ball 12 may also be removed from the ball support 14 if required, as shown in FIG. 4b. This may be done, for example, by inserting a finger or thumb into the opening 70 in the spigot 28 of the ball support 14 to push the ball 12 out through the ball aperture 22 of the ball support 14.

After disassembly, the ball 12, the ball support 14 and the retainer 16 may be discarded, or they may be cleaned for reuse. Cleaning the disassembled massage instrument 10 is easier and less time-consuming than cleaning massage instruments of the prior art, because the liquid-containing cavity is accessible through both the ball aperture 22 and the opening 70, and because there are no intricate mechanisms such as snap rings, latches or hinges to trap massage liquid or dirt.

In another embodiment of the invention, shown in FIG. 5, the massage instrument 10 may be provided as a kit comprising a single handle 18 with one or more cartridges 72. Such a cartridge 72 is shown in FIG. 6 and comprises a ball 12, a ball support 14 and a retainer 16, arranged so that the ball 12 is supported by the ball support 14, and the retainer 16 is removably attachable to the ball support 14.

Whilst the cartridges 72 may be pre-filled with a massage liquid, they may be supplied without a massage liquid so that the user can fill them if desired. Different cartridges 72 may be provided with, for example, different pre-filled massage liquids, different balls 12 made from different materials, or different ball supports 14 that support a different number of balls 12. The handle 18 can be reused with different cartridges 72 as required. This allows easy adaptation or customisation of the instrument 10 to suit different subjects, or different stages of a massage procedure.

The instrument 10 may be provided as a handle 18 with a single cartridge 72, or with a plurality of cartridges 72. Alternatively, the cartridges 72 and the handle 18 may be provided separately. It is also possible to interchange handles 18 while retaining one cartridge 72, for example an extra-long handle 18 for difficult-to-reach areas, a compact handle 18 for easy-to-reach areas, or indeed different colours and styles of handle 18 chosen for aesthetic reasons.

The massage instrument 10 of FIG. 5 is assembled as shown in FIGS. 7a to 7c. The retainer 16 is removed from the ball support 14 as shown in FIG. 7a, and is inserted into the socket 42 on the handle 18, as shown in FIG. 7b. The ball support 14 is attached to the retainer 16, as shown in FIG. 7c, and the instrument 10 is then used to deliver a massage.

After use, the instrument 10 is disassembled by the method shown in FIGS. 4a to 4c: the cartridge 72 is removed by unscrewing the ball support 14 from the retainer 16 and removing the retainer 16 from the socket 42 of the handle 18. The cartridge 72 is then discarded although it could be cleaned for re-filling and re-use. If required, a new cartridge 72 can be attached to the handle 18, for example to allow a different massage liquid to be used.

Advantageously, because the ball 12, the ball support 14 and the retainer 16 define the cavity that contains the massage liquid, the handle 18 is not exposed to the massage liquid during use of the instrument 10 and it is therefore not necessary to clean the handle 18 before replacing the cartridge 72.

The instrument 10 of the invention can be reused multiple times with different cartridges 72. In this way, different liquids can be used at different stages of the massage, or on different massage subjects, without the need to disrupt the massage in order to clean the instrument 10, or the need to provide a series of different instruments 10 for each different massage liquid.

In a further embodiment, shown in FIGS. 8 and 9, one or more cartridges 72 may comprise a ball 12 and a ball support 14 without a separate retainer 16. Instead, the retainer 16 may remain attached to the handle 18 or, as shown, may be integrated into the handle 18 by providing a female thread in the socket 42 of the handle 18. Again, a cartridge 72 shown in FIGS. 8 and 9 may be prefilled with a massage liquid. The ball support 14 may have an opening 70 for re-filling, which may be provided with a removable lid (not shown), but the embodiment shown has a fully sealed cartridge 72 that cannot be re-filled.

The ball 12, the ball support 14, the retainer 16 and the handle 18 are equivalent in all embodiments of the invention. As such, the features of the ball 12, the ball support 14, the retainer 16 and the handle 18 disclosed in relation to any one embodiment of the invention may equally apply to the ball 12, the ball support 14, the retainer 16 and the handle 18 of all embodiments of the invention.

An alternative embodiment of the massage instrument is shown in FIGS. 10 to 12, in which like numbers correspond to like parts. In this embodiment, the ball support 14 is provided as two separate components in the form of an inner housing 74 and an outer housing 76. The ball support is also provided with a protective cap 78 that is attachable to and removable from the ball support 14.

Together, the inner and outer housings 74, 76, the cap 78 and the ball 12 define a cartridge 72 that is attachable to and removable from the handle 18 and the retainer 16. In this embodiment, when the instrument 10 is in use, the cartridge 72, the handle 18, and the retainer 16 are mutually engaged, as will be described.

Considering firstly the ball support 14, as best shown in FIG. 10, the external appearance of the ball support 14 is substantially identical to the appearance of the ball support 14 described above in relation to other embodiments of the invention. The ball support 14 comprises an upper portion that comprises a spigot 28 that extends into the socket 42 of the handle 18 when the cartridge 72 is in use, and a lower portion that comprises two opposed frustoconical sections 24 joined at their mutual base 26, and defining a ball aperture 22.

In this embodiment, the spigot 28 is not provided with a male screw thread, but instead an outer surface of the spigot 28 is provided with male engagement formations 80 in the form of a plurality of protruding elements, here being integral with the spigot 28. The protruding elements 80 are substantially cuboidal in shape, and are arranged regularly around the spigot 28. Upper surfaces 82 of the protruding elements 80 are tapered, so as to define a bearing surface, while lower surfaces 84 of the protruding elements 80 are orthogonal to the outer surface of the spigot 28, so as to define a shoulder. In use, and as will be later described, the protruding elements 80 provide a means for attaching the ball support 14 to the handle 18.

Although the outer appearance of the ball support 14 is similar to that of the previous embodiments, in this embodiment the ball support 14 differs in that it comprises an inner housing 74 and an outer housing 76. The internal structure of the ball support 14 therefore differs from the internal structure of the ball support 14 of the previous embodiments, as will now be described.

The inner housing 74 comprises an upper portion 86 and a lower portion 88. As best shown in FIGS. 11 and 12, when the cartridge 72 is assembled, a majority of the inner housing 74 is received inside the outer housing 76. A lowermost portion 89 of the inner housing 74 protrudes from the outer housing 76 and defines the ball aperture 22. In use, the upper portion 86 receives massage liquid, and the lower portion 88 comprises an internal cavity 90 that receives the ball 12.

Conveniently, as shown in FIGS. 11 and 12, the upper portion 78 of the inner housing 74 comprises a tray 92 that receives the massage liquid. The tray 92 is defined by a circular base 94, and an annular wall 96 that surrounds, and is arranged generally orthogonal to, the base 94. The base 94 provides a boundary between the tray 92 of the upper portion 86 and the internal cavity 90 of the lower portion 88.

To allow the massage liquid in the tray 92 to contact the ball 12, the base 94 is provided with an aperture 98, which is surrounded by an annular aperture wall 100 that extends a short distance into the tray 92. A lower surface 102 of the circular base 94 is concave in the region surrounding the aperture 98, so as to provide a rounded bearing surface that accommodates the ball 12. Thus, when the ball 12 is arranged in the internal cavity 90, the ball 12 is arranged to extend a short distance into the aperture 98. In this way, massage liquid can pass from the tray 92, through the aperture 98, to an outer surface of the ball 12.

The lower portion of the inner housing 74 is arranged below the base of the tray, and comprises an annular collar 104. As best shown in FIG. 10, externally, the annular collar 104 comprises a series of annular walls 106. The annular walls 106 are of increasing diameter moving from the annular wall 106 nearest the base 94 of the tray 92 to the annular wall 106 nearest the ball aperture 22. In this way, the outer surface of the lower portion 88 comprises a stepped profile.

The uppermost annular wall 108 of the lower portion 88 comprises an outer surface 110 that is provided with lugs 112 of substantially cuboidal shape. In the assembled cartridge 72, the lugs 112 of the inner housing 74 align with recesses (not shown) in the outer housing 76 that will be later described, so as to align the inner and outer housings 74, 76, and to prevent rotational movement of the inner housing 74 with respect to the outer housing 76.

As best seen in FIGS. 11 and 12, the stepped outer profile is also provided with a lip 116. The lip 116 is an annular wall that faces and is spaced away from the uppermost annular wall 108 of the lower portion 88. In this way, a channel 118 is defined between the annular wall 108 and the lip 116. The channel 118 is dimensioned to receive a protruding element 120 provided internally on the outer housing 76, to be further described. The engagement between the protruding element 120 and the channel 118 provides further frictional engagement between the inner and outer housings 74, 76.

The lowermost annular wall 89 of the lower portion 88 of the inner housing 74 is tapered, so as to define a frustoconical surface. In the assembled cartridge 72, this frustoconical surface provides the lowermost portion 89 that protrudes from the outer housing to define the ball aperture.

With reference to FIGS. 11 and 12, the internal profile of the lower portion 88 of the inner housing 74 mimics the external profile, and hence comprises a stepped inner profile. Corners 124 of the stepped inner profile define bearing surfaces that receive and retain the ball 12. Between the bearing surfaces 124, the profile comprises a series of circumferential cavities 126 arranged in communication with the ball 12. These cavities 126 receive massage liquid when the instrument 10 is in use.

Turning now to the outer housing 76, as best seen in FIG. 10, the outer housing 76 comprises an upper portion 128 and a lower portion 130. The upper portion 128 of the outer housing 76 defines the spigot 28 that is received into the socket 42 of the handle 18. The upper portion 128 of the outer housing 76 also receives the upper portion 86 of the inner housing 74, and defines a cover 132 that covers the tray 92 of the inner housing 74, to prevent the massage liquid escaping from the cavity 90 (see FIGS. 11 and 12). In use, the cover 132 prevents the massage liquid coming into contact with the handle 18 and the retainer 16, thereby avoiding contamination, and minimising the need to clean the handle 18 and the retainer 16 between uses.

The cover 132 comprises a substantially flat circular upper lid 134 surrounded by an annular outer wall 136 that is arranged orthogonal to the upper lid 134. In the assembled cartridge 72, the annular outer wall 136 is arranged in facing contact with the annular wall 96 of the tray 92 of the inner housing 74. Said another way, an inner surface of the annular outer wall 136 of the outer housing 76 abuts an outer surface of the annular wall 96 of the tray 74. The upper lid 134 is arranged parallel to, and spaced apart from, the base 94 of the tray 92.

Internally, the upper lid 134 is provided with an inner rim 138 extending orthogonal to the upper lid 134. The inner rim 138 is spaced apart from the annular outer wall 136 by a distance that is approximately equal to a thickness of the annular wall 96 of the tray 92. In this way, in the assembled cartridge 72, the annular wall 96 of the tray 92 is received between the inner rim 138 and the annular outer wall 136, and is retained therein by friction.

The upper portion 128 or spigot 28 of the outer housing 76 extends downwardly from the upper lid 134 to meet the lower portion 130 of the outer housing 76. The lower portion 130 is wider than the adjoining part of the upper portion 128, such that an annular shoulder 30 is defined between the upper and lower portions 128, 130.

Considering now the lower portion 130 of the outer housing 76, as best seen in FIGS. 11 and 12, the lower portion 130 comprises an annular collar 140. The external shape of the collar 140 comprises upper and lower frustoconical sections 24 joined at their mutual base 26.

Internally, the lower frustoconical section 24 comprises a substantially flat inner vertical surface 142. When the cartridge 72 is assembled, the inner vertical surface 142 lies against one of the annular walls 106 of the inner housing 74, so as to provide a frictional engagement.

An inner surface 144 of the upper frustoconical section 24 is also substantially flat, and extends upwardly at an angle of less than 180° to the inner surface 142 of the lower frustoconical section 24. As best shown in FIGS. 10 and 11, the protruding element 120 previously mentioned, in the form of annular wall 120 depends downwardly from an inside surface of the annular shoulder 30. The annular wall 120 comprises recesses (not shown) that are dimensioned and spaced to receive the lugs 112 of the inner housing 74, so as to align the inner and outer housings 74, 76, and to prevent relative rotational movement between them as previously described.

To protect the ball 12 when the massage instrument 10 or the cartridge 72 is not in use, a cap 78 is conveniently provided. The cap 78 of the cartridge 72 comprises a lower portion 146 that receives the protruding ball 12, and an upper portion 148 that engages with the outer housing 76 of the ball support 14. The lower portion 146 is shaped as a truncated spherical shell. The upper portion 148 is contiguous with the lower portion 146, and is shaped to mimic the external profile of the ball support 14. Hence, the upper portion 148 of the cap 78 is shaped as two opposed frustoconical sections joined at their mutual base. When engaged with the ball support 14, an inner surface of the cap 78 abuts the frustoconical portions of the ball support 14, providing a frictional engagement between the cap 78 and the ball support 14.

To assemble the cartridge 72, the ball 12 is first arranged within the inner housing 74 by pushing the ball 12 through the ball aperture 22. The tray 92 of the inner housing 74 is then filled with massage liquid. The inner housing 74 is then pushed upwardly into the outer housing 76, so that the cover 132 of the outer housing 76 covers the tray 92 of the inner housing 74, preventing liquid from escaping.

In this embodiment, the inner and outer housings 74, 76 engage by means of a plurality of frictional engagements. Firstly, the annular wall 96 of the tray 92 is received between the rim 138 and the outer wall 136 provided on the lid 134 of the outer housing 76. Secondly, the annular wall 120 that depends downwardly from the inner surface of the shoulder 30 of the outer housing 76 engages with the channel 118 provided by the lip 116 of the inner housing 74. Thirdly, the inner surface 142 of the lower frustoconical portion 24 of the outer housing 76 engages with the annular wall 106 of the inner housing 74.

As described, when the inner housing 74 is arranged within the outer housing 76, the lower frustoconical section 89 of the inner housing 74 protrudes from the outer housing 76. Specifically, the lower frustoconical section 24 of the outer housing is contiguous with the lower frustoconical section 89 of the inner housing 74, such that the frustoconical sections define the lower frustoconical section 24 of the ball support 14.

The lower frustoconical section 24 of the outer housing 76 also exerts an inward force on the lower frustoconical section 89 of the inner housing 74. This inward force reduces the size of the ball aperture 22, so as to retain the ball 12 within the inner housing 74. Thus, the ball 12 can be easily inserted through the ball aperture 22 into the inner housing 74 before the cartridge 72 is assembled, but is securely retained within the inner housing 74 when the cartridge 72 is assembled for use.

The cap 78 is then pushed upwardly over the ball 12 and the ball support 14 to engage with the frustoconical portions 24 of the ball support 14. The cap 78 serves two purposes: firstly, it protects the ball 12, preventing grit and dirt contaminating the ball surface, and, secondly, it catches any massage liquid that leaks out from the cavity 90 during storage of the instrument 10, preventing the liquid from escaping.

The simple snap-fit method of assembly of the cartridge 72 allows for mechanised assembly of the cartridge 72. For example, the cartridge 72 may be filled and assembled on a filling line, to allow for high-volume production of the cartridges 72.

For use of the instrument, and as shown in FIG. 12, the cartridge 72, the handle 18 and the retainer 16 are mutually engaged to secure the cartridge 72 to the handle 18. The retainer 16 and the handle 18 are engaged with one another substantially as described with regard to the previous embodiments. Specifically, the retainer 16 is received by the socket 42 of the handle 18, so as to lie flush with the outer surface of the handle 18. Alternatively, the retainer 16 may be integral with the handle 18.

The cartridge 72 and the handle 18 engage by means of cooperable male and female engagement formations 80, 150. The male engagement formation 80 is provided on the spigot 28 of the ball support 14 in the form of the protruding elements 80 already described above. The female engagement formations 150 are provided on the handle 18, as will now be described.

As best seen in FIG. 11, the handle comprises a flange 66. An inner surface 152 of the flange 66 of the handle 18 is provided with a lip 154 that extends into the socket 42. The lip 154 is provided with female engagement formations 180 in the form of L-shaped slots. A vertical portion of the L-shaped slot 180 extends upwardly from the lower surface of the flange 66, and a horizontal portion of the L-shaped slot 180 extends circumferentially from the vertical portion, around the socket 42.

In this way, the male and female engagement formations 80, 150 form a bayonet-type fitting that requires a ‘push-and-twist’ action to engage the cartridge 72 and the handle 18.

To mutually engage the cartridge 72, the handle 18 and the retainer 16, the retainer 16 is firstly placed within the socket 42 of the handle 18. The male engagement formations 80 on the ball support 14 and the female engagement formations 150 on the handle 18 are then aligned. The male engagement formations 80 are firstly pushed upward into the vertical portion of the L-shaped slots 150. This also pushes the spigot 28 of the ball support 14 through the socket 42 and into the skirt 32 of the retainer 16, so that the ball support 14 and the retainer 16 engage by means of a frictional engagement.

The cartridge 72 is then rotated, such that the male engagement formations 80 are rotated and pushed into the horizontal portions of the L-shaped slots 150. The fitting provides a reassuring sound and feel when the male and female engagement formations 80, 150 have been properly engaged, so that the user knows that the cartridge 72 has been properly engaged with the handle 18.

Once the cartridge 72 is fitted, the shoulders 84 of the protruding elements 80 engage with the lip 154 of the flange 66 to prevent downward movement of the cartridge 72. The frictional engagement between the retainer 16 and the cartridge 72, and between the retainer 16 and the handle 18, prevents rotational movement of the cartridge 72 when the instrument 10 is in use. In this way, the cartridge 72 is securely held in place by the mutual engagement between the handle 18, the retainer 16 and the cartridge 72, and the instrument 10 can be used without risk of disengaging the cartridge 72.

The instrument 10 can then be used as has already been described. Once the massage liquid has been used, the cartridge 72 can be removed and swapped for a different cartridge 72, or the instrument 10 can be stored for future use.

To disengage the cartridge 72, a sharp rotational force is applied to the cartridge 72, to overcome the frictional engagement between the retainer 16 and the cartridge 72, and between the cartridge 72 and the handle 18. The cartridge 72 can then be rotated and pulled to disengage the male and female engagement formations 80, 150, thereby removing the cartridge 72 from the handle 18.

It will be appreciated that many variations in the design of the instrument are possible within the scope of the invention. For example, the retainer 16 need not comprise a substantially flat disc 34, but may be any suitable shape.

The retainer may be integral with the holder. In a variant of the instrument, it is also envisaged that the retainer may be located on the lower surface of the holder, such that the ball support and retainer connect to the lower surface of the handle.

The ball support 14 need not be formed from two opposed frusto-conical members as shown in FIG. 1a, but may be any suitable shape. It need not have an opening 70 to receive a massage liquid; for example, the massage liquid could instead be received through the ball aperture 22 prior to insertion of the ball 12.

The handle 18 may hold multiple ball supports 14, and/or the ball supports 14 may hold multiple balls 12, each ball 12 protruding through a different ball aperture 22. The handle 18 may be of any suitable shape and may be shaped to facilitate self-massage, or to deliver a massage to a subject other than the user.

The handle 18 need not have a socket 42 through which the ball support 14 and the retainer 16 are attached. For example, the ball support 14 and the retainer 16 may extend around the handle 18 so as to be removably attached. The ball support 14 and the retainer 16 need not be attached by means of screw threads, but may be attached by any suitable attachment means, for example a latch mechanism or a frictional attachment.

The cartridges 72 need not be prefilled with a massage liquid, but may instead be provided without massage liquid, so that the user can fill the cartridge 72 with a massage liquid of his or her own choosing, or leave the cartridge 72 unfilled if desired.

1. A roller-ball massage instrument comprising:
a ball support arranged to support a ball protruding from and rotatable with respect to the ball support;
a retainer cooperable with the ball support; and
a holder to hold the ball support.

2. The instrument of claim 1, wherein the holder is positionable between the ball support and the retainer.

3. The instrument of claim 1, wherein the ball support comprises an opening for receiving a massage liquid.

4. (canceled)

5. The instrument of claim 3, wherein the ball, the ball support and the retainer define a cavity in communication with an outer surface of the ball, the cavity being capable of holding the massage liquid, and wherein the ball support and/or the retainer prevent the massage liquid in the cavity from contacting the holder.

6. (canceled)

7. The instrument of claim 1, wherein the ball support is removably attachable to the retainer and/or the holder.

8. (canceled)

9. The instrument of claim 1, wherein the holder comprises a socket and the ball support and the retainer extend at least partially through the socket to cooperate with each other.

10. (canceled)

11. (canceled)

12. The instrument of claim 7, wherein the ball support and the holder are cooperable by means of a fitting selected from the group consisting of: a screw fitting, a push fitting and a bayonet fitting.

13. (canceled)

14. The instrument of claim 7, wherein the ball support, the holder and the retainer are mutually cooperable.

15. The instrument of claim 1, wherein the ball support comprises a spigot and a collar, the spigot being narrower than the collar; and wherein the collar overlaps the spigot to define a ball support shoulder that bears against the holder.

16. (canceled)

17. The instrument of claim 15, wherein the socket is surrounded by a flange on an inner side of the holder and the ball support shoulder bears against the flange.

18. The instrument of claim 1, wherein the retainer comprises a skirt and a disc, the skirt being narrower than the disc; and wherein the disc overlaps the skirt to define a retainer shoulder.

19. (canceled)

20. The instrument of claim 18, wherein the socket comprises a stepped inner profile that defines a seat surface against which the retainer shoulder bears in use.

21. (canceled)

22. The instrument of claim 2, wherein the holder is clamped between the ball support and the retainer.

23. (canceled)

24. (canceled)

25. The instrument of claim 1, wherein the ball support comprises an inner housing and an outer housing.

26. The instrument of claim 25, wherein the inner housing comprises an opening for receiving a massage liquid.

27. The instrument of claim 26, wherein, in use, the outer housing closes the opening.

28. The instrument of claim 27, wherein the ball, the inner housing and the outer housing define a cavity in communication with an outer surface of the ball, the cavity being capable of holding a massage liquid.

29. (canceled)

30. The instrument of claim 1, wherein the ball, the ball support and the retainer constitute a cartridge removable from the holder, such that the holder may be re-used with a fresh cartridge.

31. A cartridge for use with the massage instrument of claim 30, comprising a ball support arranged to support a ball protruding from and rotatable with respect to the ball support, and a retainer cooperable with the ball support.

32. (canceled)

33. The instrument of claim 1, wherein the ball and the ball support constitute a cartridge removable from the holder, such that the holder may be re-used with a fresh cartridge.

34. (canceled)

35. A cartridge for use with the massaging instrument of claim 33, comprising a ball support arranged to support a ball protruding from and rotatable with respect to the ball support, the ball support having an attachment formation for attaching the cartridge to the retainer.

36. The cartridge of claim 35, wherein the cartridge is pre-filled with a massage liquid in a cavity defined by the ball and the ball support.

37. A roller-ball massage instrument comprising:
a handle; and
a cartridge containing massage liquid and having a ball protruding from and rotatable with respect to the remainder of the cartridge to apply the massage liquid to a subject in use;
wherein the cartridge is removably attachable to the handle such that the handle can be reused with a fresh cartridge.

38. The roller-ball massage instrument of claim 37, wherein the ball, a ball support and a retainer constitute the cartridge.

39. A roller-ball massage instrument kit comprising:
a handle; and
a set of cartridges each containing massage liquid and having a ball protruding from and rotatable with respect to the remainder of the cartridge to apply the massage liquid to a subject in use;
wherein each cartridge of the set is removably attachable to the handle such that the handle can be reused with a fresh cartridge.

40. (canceled)

41. The kit of claim 39, wherein different cartridges of the set of cartridges contain different massage liquids and/or wherein different cartridges of the set of cartridges have balls of different size, material, structure, content or composition.

42.-44. (canceled)
